(19) United States
(12) Patent Application Publication
(10) Pub. No.: US 2026/0219185 A1
(43) Pub. Date: Jul. 30, 2026

(54) A NOVEL SELF-ASSEMBLED ORGANIC NANOSENSOR FOR ALBUMIN PROTEIN DETECTION

(71) Applicant: Prantae Solutions Private Limited, Bhubaneswar, Mancheswar, Khorda (IN)

(72) Inventors: Sumona Karjee Mishra, IRC Village, Bhubaneswar (IN); Aseem Mishra, IRC Village, Bhubaneswar (IN)

(21) Appl. No.: 19/148,700

(22) PCT Filed: May 28, 2023
(86) PCT No.: PCT/IN2023/050508

§ 371 Date: Jul. 17, 2025

(30) Foreign Application Priority Data
Apr. 3, 2023 (IN) 202331025374

(51) Int. Cl. G01N 21/64; G01N 21/77

(52) U.S. Cl. CPC G01N 21/6428; G01N 2021/7786

(57) ABSTRACT

The present invention describes the synthesis of a novel self-assembled organic nanosensor. The self-assembled organic nanosensor is naphthalene sulphonate backbone with a size distribution of 40-2000 nanometers. The self-assembled organic nanosensor exhibits very low auto-fluorescence however, it exhibits high fluorescence activity in presence of albumin protein therefore, the signal is to noise ratio will be high. The fluorescence generated is directly proportional to the concentration of the albumin protein and can be used for quantification of the albumin in sample. The self-assembled organic nanosensor can quantify 0.1 mg/L-3500 mg/L range of albumin concentration linearly. The nanosensor exhibits fluorescence between 5 to 10 seconds of introduction of self-assembled organic nanosensor to the sample containing albumin. The interaction with self-assembled organic nanosensor exhibits the stability to the albumin protein for 20 days in aqueous solution and is stable between −80 degree to +95 degree Celsius.

### FIELD OF THE INVENTION

The present invention relates to the process of synthesis of a novel self-assembled organic nanosensor and the method of albumin detection using nanosensors. More specifically, the invention describes a process for preparation of self-assembled organic nanosensor that has very low auto-florescence and gives stable high fluorescence in presence of albumin upon photo excitation. The self-assembled organic nanosensor is used to qualitatively and quantitatively estimate albumin in solutions and solid support

### BACKGROUND OF THE INVENTION

Albumin is a very important protein that constitute 54% of Egg protein, 22% of milk protein, 36% of whey protein, and 50-60% of human serum protein. Albumin besides its nutritional value has wide industrial and research applications. Egg albumin protein is a valuable ingredient in many food products, including pet food, due to its ability to thermally coagulate and bind ingredients. Bovine serum albumins are used in vaccine production and have profound value in cell culture related work, including effective washing of cells and in cryopreservation. Human serum albumin has been used as biomarker for the detection of various physiological conditions and health monitoring. The qualitative and quantitative estimation is very important for its industrial and research application and quality control. Fake eggs made of sodium alginate as reported by Hosen et al., 2013 for albumin can be identified with rapid qualitative analysis on site. Serum albumin concentration of donor cows determines the developmental competence of oocytes as reported by Smuts et al., 2019 and can be helpful if determined quantitatively on field. The serum albumin is used to study the higher specificity and better pharmacokinetic performance of various drugs. The albumin is useful in the detection of kidney health status with urine sample or dehydration with high level of serum sample.

The albumin can be detected qualitatively and quantitatively with various sensors. Following are few prior art in albumin detection mechanism

Chromogenic sensors, the organic dye that gives color indicative reaction with albumin. Folin-Ciocalteu sensor (Lowry's method (GB1596914A)) interacts with the cuprous ions and the side chains of tyrosine, tryptophan, and cysteine to produce a blue-green color that can be detected between 650 nm and 750 nm. However, the slow colour development that fades relatively rapidly, so reasonable precise reaction times and temperatures are required. This can be a problem when analyzing many samples and on field testing.

Coomassie brilliant blue dye used as sensor in Bradford method (U.S. Pat. No. 4,023,933A) that binds to positively-charged proteins. When the dye is in solution, it's red and absorbs at 465 nm—but when it binds to basic amino acids in the protein, it becomes blue and absorbs at 595 nm. Major disadvantage with the method is very messy and stains clothes, skin etc.

Bromo Cresol Green an anionic sensor (BCG method (U.S. Pat. No. 3,873,272A)), that interact with the protein at acid pH produce a color change of the indicator from yellow-green to green-blue with the resulting shift in the absorption wavelength of the complex. However, the method is so responsive to pH condition that variation leads to false positive or negative.

Bicinchoninic acid is used as sensor (BCA method (DE602004007769T2)). The principle of this method is that proteins can reduce Cu²⁺ to Cu¹⁺ in an alkaline solution (the biuret reaction) and result in a purple color formation by bicinchoninic acid.

The immune chromatography is a qualitative method that enables visual determination of whether the result is negative or positive. Also, the measurement takes a long time, often 10-15 minutes, until the liquid sample has completed its movement along the strip.

Immunoturbidity are antibody-based method where albumin specific antibody interacts with albumin in the sample to form complex. The correct balance of albumin and antibody leads to the formation of complexes can be followed in a spectrophotometer as flocculation occurs and absorbance increases. It is rapid but require laboratory setup to perform the assay. In-addition it is more appropriate at lower biological concentration at a very narrow range and does not able to measure higher biological concentrations. Fluorescent sensors

Protein biosensors based on fluorescent organic materials have attracted much attention due to their functionality, sensitivity, selectivity, and rapidity. Anionic cyanine dyes (U.S. Pat. No. 5,182,214A) that describes high sensitivity towards HSA and have linear response over 0-40 mg/L with emission wavelength at 640 nm. A problem often encountered by conventional fluorophores is aggregation-caused quenching (ACQ) because of TT-TT stacking interactions in the planar fluorophores. When they are dispersed in aqueous media or bound to protein in buffer solution, the molecules are inclined to aggregate, which quenches their fluorescence and thus greatly limits their effective ranges as bioprobes.

However, there is another class of fluorescent organic material that exhibits aggregation induced emission (AIE). US20130177991A1 describes tetraphenylethene functionalized with sulphonated group for the estimation of urinary protein based on AIE with high sensitivity. It further describes that the AIE-active in the monomeric form emits faintly in PBS buffer but gives strong light upon aggregate formation. Its solution in PBS buffer is weakly luminescent at 390 nm while in the presence of HSA induces the AIE compound to emit intensely at 475 nm.

### Nanoparticle Based Sensors

Metallic nanoparticle based nanosensors such as gold nanoparticle based sensors have been described by Huang et al., 2015. The method is based on the change in surface plasmon response upon adsorption of albumin on the surface of the gold nanoparticle sensor. Lai et al., 2016 used gold nanoparticle sensor that in presence of albumin gives red color while in absence of albumin aggregate to give blue color.

Thus, the existing methods of albumin detection described in preceeding paragraphs have several drawbacks. Chromogenic dyes have the limitations of low specificity towards albumin. Further they are multistep reaction and require laboratory setup to conduct the assay making them unfeasible for on site or on field or point of care. Immunoresponsive probes are highly specific but has a very narrow range of detection. It requires skilled operator and laboratory equipment for the assay. Further, they can identify only the immune responsive fraction of the albumin protein in the sample and does not capture the non-immune responsive albumin resulting in underrepresentation of the total albumin content of a sample. The fluorescent probes are promising, however there is reported aggregation induced quenching phenomenon that makes them unsuitable for industrial application.

The Aggregation Induced Emission class of fluorescence sensors are promising but their synthesis is complex and expensive. Therefore, there is a large unmet need for a sensor that has broad range of detection for albumin protein, simple assay with minimum requirement of laboratory equipment and facility yet easy and cost effective to synthesize, highly stable for broad industrial, medical and laboratory application.

Nanosensors are the submicron size nanoscale chemical or mechanical sensors that can be used to detect the presence of chemical species and nanoparticles, or monitor physical parameters such as temperature. They find wide application in medical diagnostic applications, food and water quality sensing, and other chemicals. Self-assembly of nanostructures is a process where atoms, molecules or nanoscale building blocks spontaneously organize into ordered structures or patterns with nanometer features. It is the most promising practical low-cost and high-throughput approach for nanofabrication.

Present invention describes a method of synthesis of novel self-assembled organic nanosensor of naphthalene sulfate backbone which has illustrated broad range of detection 0.1-3500 mg/L, highly specific for albumin protein and a cost effective, stable wherein the process can detect the presence of albumin protein in sample without any lab equipment.

Therefore, to the best of our knowledge, none of the above mentioned prior art attempts, individually or collectively indicates the proposed system and embodiments indicated and disclosed by the present invention.

### OBJECT OF THE INVENTION

The objective of the present invention is the synthesis of novel self-assembled organic nanosensor of low auto-fluorescence from the fluorophore monomeric backbone of naphthalene sulfonate.

Another objective of the present invention is to provide albumin detection by self-assembled organic nanosensor with high signal to noise ratio.

Further objective of the present invention is to develop a kit that can enable measurement of albumin from the environmental, biological or synthetic sample on field, or on site or point of care in solid state or in solution for testing and diagnosis.

### SUMMARY OF THE INVENTION

The present invention describes the synthesis of a novel self-assembled organic nanosensor. The self-assembled organic nanosensor has naphthalene sulphonate backbone with a size distribution of 220-360 nanometers. The self-assembled organic nanosensor exhibits very low auto-fluorescence however, it exhibits high fluorescence activity in presence of albumin protein and the signal is to noise ratio will be high. The fluorescence generated is directly proportional to the concentration of the albumin protein and can be used for quantification of the albumin in sample. The self-assembled organic nanosensor can quantify 0.1 mg/L-3500 mg/L range of albumin concentration linearly. The fluorescence can be observed without any device through visual inspection and can also be determined with fluorescence spectrophotometric or fluorescence imaging device for qualitative and quantitative analysis. The self-assembled organic nanosensor can give fluorescence between 5 to 10 seconds of introduction of self-assembled organic nanosensor to the sample containing albumin protein. The interaction with self-assembled organic nanosensor gives stability to the albumin protein in aqueous solution for 20 days. The self-assembled organic nanosensor is stable between −80 degree to +95 degree Celsius.

### BRIEF DESCRIPTION OF THE DRAWING

Complete understanding of the system and method of the present invention may be obtained by reference to the following Figures

FIG. 1: Transmission Electron Micrograph images. 1-A TEM image demonstrates different sizes of the self-assembled organic nanosensor ranging from 40 nm to 800 nm and 1-B TEM image demonstrates different sizes of the self-assembled organic nanosensor ranging from 500 nm to 2000 nm.

FIG. 2: Dynamic Light Scattering for size characterization of monomer and self-assembled organic nanosensor. 2-A Particle size distribution histogram of the self-assembled organic nanosensor where the major peak is at 229.8 nm. Graph plot of auto-correlation function of self-assembled organic nanosensor (2-B), monomer (2-C), self-assembled organic nanosensor with albumin protein (2-D) and monomer with albumin protein (2-E).

FIG. 3: Model of albumin protein interaction with self-assembled organic nanosensor and monomeric backbone.

FIG. 4: Absorption spectrum of monomer and self-assembled organic nanosensor.

FIG. 5: Fluorescence spectra of excitation (5-A) and emission (5-B) of monomer and self-assembled organic nanosensor.

FIG. 6: Fluorescence emission spectra of self-assembled organic nanosensor alone and with albumin protein.

FIG. 7: Concentration curve plot of self-assembled organic nanosensor with albumin protein.

FIG. 8: Specificity data of self-assembled organic nanosensor analyzed with albumin and non-albumin proteins. Relative fluorescence intensity output of the interaction between the self-assembled organic nanosensor and albumin protein; human serum albumin (HSA) bovine serum albumin (BSA), lactoalbumin, ovalalbumin, and non-albumin protein; lysozyme, trypsin.

FIG. 9: Graph plot of stability of the albumin alone and with self-assembled organic nanosensor over a time period of 20 days.

FIG. 10: Determination of unknown concentration in a bovine urine sample using the self-assembled organic nanosensor kit. 10-A graphical representation of the albumin protein content of the bovine urine sample tested in solution and 10-B represents bovine serum albumin qualitative detection through interaction with self-assembled organic nanosensor on solid matrix. Left panel picture of only nitrocellulose paper impregnated with self-assembled organic nanosensor through slot blot and right panel picture of only nitrocellulose paper impregnated with self-assembled organic nanosensor treated with bovine milk sample over UV-trans-illuminator.

### DETAILED DESCRIPTION OF THE EMBODIMENT

The following is a detailed description of embodiments of the disclosure depicted in the accompanying drawings. The embodiments are in such detail as to clearly communicate the disclosure. The amount of detail offered has the intention to cover all modifications, equivalents, and alternatives falling within the scope of the present disclosure as defined by the appended claims.

The accompanying drawings, which are incorporated in and constitute a part of the specification, illustrate an embodiment of the invention, and together with the description, serve to explain the principles of the inventions.

As used in the description herein and throughout the claims that follow, the meaning of “a,” “an,” and “the” includes plural reference unless the context clearly dictates otherwise.

The invention provides a method of synthesis of a self-assembled organic nanosensor. Nanosensors are the submicron size nanoscale chemical or mechanical sensors that can be used to detect the presence of chemical species and nanoparticles, or monitor physical parameters such as temperature. In the present invention the nanosensor described is a nanoscale chemical sensor. The sensor has wide application in medical diagnostic applications, food and water quality sensing, and other chemicals. The nanosensor has been synthesized by creating a micro-environment to promote self-assembly. Self-assembly of nanostructures is a process where atoms, molecules or nanoscale building blocks spontaneously organize into ordered structures or patterns with nanometer features. It is the most promising practical low-cost and high-throughput approach for nanofabrication. In the present invention monomeric backbone used has a following chemical nature

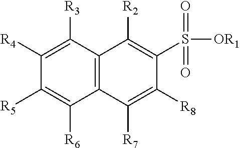

Where R can be but not limited to hydrogen, sodium, carbon, chloride, fluorine, sulphur, hydroxyl, amine, methyl, oxymethyl, acetyl, acetylamine, phenyl, nitoxide.

In the preferred embodiment, the synthesis process comprises of two steps. In the first step the monomeric backbone was dissolved in an alkaline solution, where the concentration of the naphthalene sulphonate monomeric backbone can be in the range of 100 millimolar (mM) to 5 molar (M) solution. The pH range of the alkaline solution can be between pH 8-12, where the alkali solution can be but not restricted to barium hydroxide, sodium hydroxide, ammonium hydroxide, calcium hydroxide, lithium hydroxide, and potassium hydroxides, sodium bicarbonate of molarity 250 millimolar (mM) to 4 molar (M). Incubate the solution for 1 hour to 96 hours for stabilization. The second step is to mix the alkaline solution of monomeric backbone to buffered aqueous solution with a pH range of 3-5, where the molarity of the buffer solution can be between 50 millimolar to 2.5 molar, where the buffer solution can be but not limited to citrate, formate, ascorbate, phosphate, tris, carbonate. The ratio of alkaline monomeric backbone solution to buffered aqueous solution can be in the range between 0.001 to 10.

The solution is incubated in closed container of glass or plastic for 12-86 hours in dark at temperature range of 27 to 57 degree Celsius. The large self-assembled super-structures can be visualized with naked eye that settled at the bottom of the container that on shaking disperse homogenously. The self-assembled organic nanosensors are then collected as pallet by centrifugation at 10000 rpm for 10 minutes. The supernatant is discarded and the self-assembled organic nanosensor is resuspended in deionized water.

In another embodiment, the synthesis process comprises of dissolving naphthalene sulphonate momomeric backbone in an organic solvent, where the concentration of the naphthalene sulphonate momomeric backbone can be in the range of 100 millimolar (mM) to 5 molar (M) solution. The organic solvent can be but not restricted to Dimethyl Formamide, methanol, tetrahydrofuran and similar, where the concentration can be in the range of 10-100%. Incubate the solution for 1 hour to 96 hours for stabilization. The second step is to mix the momomeric backbone in organic solvent to buffered aqueous solution with a pH range of 3-5, where the molarity of the buffer solution can be between 50 millimolar to 2.5 molar, where the buffer solution can be but not limited to citrate, formate, ascorbate, phosphate, tris, carbonate. The ratio of alkaline naphthalene sulphonate momomeric backbone solution to buffered aqueous solution can be in the range between 0.001 to 10. The solution is incubated in closed container of glass or plastic for 12-86 hours in dark at temperature range of 27 to 57 degree Celsius. The large self-assembled super-structures can be visualized with naked eye that settled at the bottom of the container that on shaking disperse homogenously. The self-assembled organic nanosensors are then collected as pallet by centrifugation at 10000 rpm for 10 minutes. The supernatant is discarded and the self-assembled organic nanosensor is resuspended in deionized water.

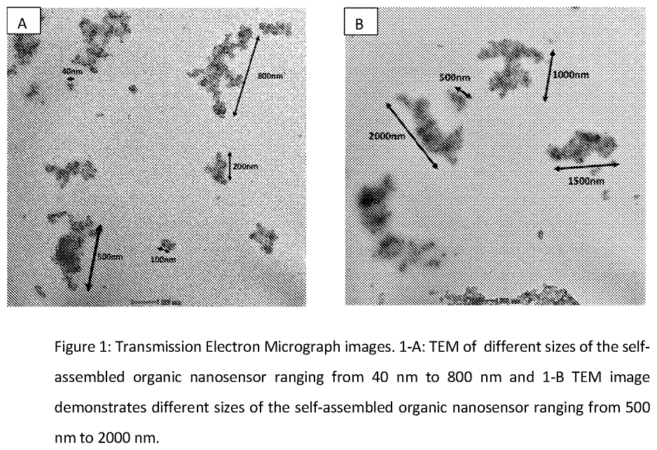

FIG. 1 presents the Transmission Electron Micrograph (TEM) images of the self-assembled organic nanosensor, where the smallest unit of self-assembled organic nanosensor is approximately 40 nanometer (nm) while the higher order sizes made by the self-assembled organic nanosensor size range is about 2000 nanometers. FIG. 1-A TEM image demonstrates different sizes of the self-assembled organic nanosensor ranging from 40 nm to 800 nm and FIG. 1-B, TEM image demonstrates different sizes of the self-assembled organic nanosensor ranging from 500 nm to 2000 nm. The electron micrograph grid has mixture of various preparation of self-assembled organic nanosensors with an 250 mM to 4M alkaline solution pH 8-12 of monomeric backbone concentration range of 100 mM to 5M in weak acidic solution Formic acid in a concentration range of 50 mM to 2.5M in water, incubated in glass container at 27 degree Celsius. Thus, the self-assembled organic nanosensor size is in the range of 40 nanometer to 2000 nanometer.

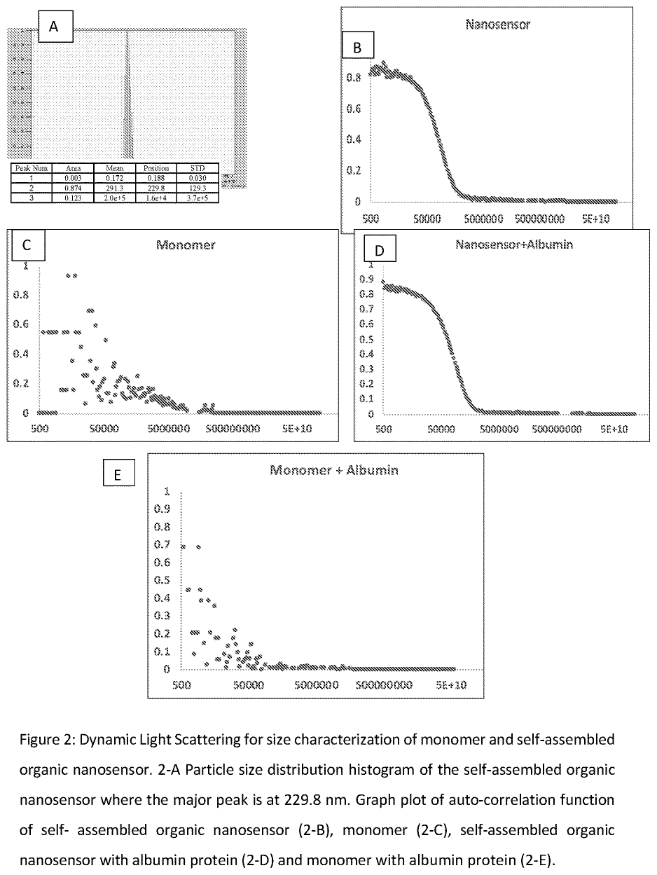

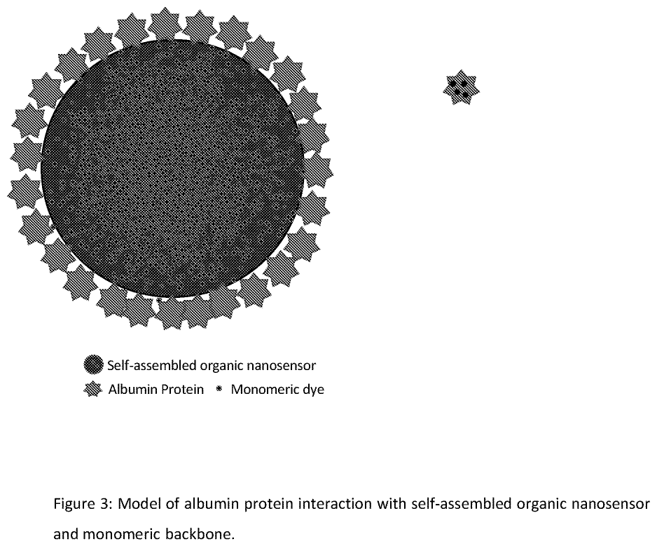

FIG. 2 illustrates the Dynamic Light Scattering data of the self-assembled organic nanosensor. The nanosensor has been synthesized with an alkaline solution of monomeric backbone concentration of 500 mM and Ascorbic Acid solution with a concentration of 50 mM, incubated for 72 hours at 57 degree Celsius at dark in plastic container. Sample was analyzed with Photocor Complex equipment from Photocor Instruments, Estonia. The particle size distribution analysis obtained from the auto-correlation function determines the size of the nanosensor shows a major peak between 220-360 nanometers with goodness of fit c²=0.017 suggesting the size of the self-assembled organic nanosensor is in the range of 220-360 nm FIG. 2-A. The self-assembled organic nanosensor has exhibit scattered distribution with the exponential decay in the auto-correlation function suggesting larger particle nature with size distribution of 220-360 nm FIG. 2-B, while the monomeric backbone because of its extremely small size could not display exponential decay in the auto-correlation function FIG. 2-C, suggesting the monomeric backbone is less than 2 nm size. In presence of the albumin protein also the monomeric backbone has shown no self-assembly or aggregation, as the auto-correlation function remain similar with or without albumin protein, no exponential decay FIG. 2-D. Thus, the self-assembly into organic nanosensor is promoted by the treatment of the backbone through a specific process and not in presence of the albumin protein. Also, the self-assembled organic nanosensor is stable and retain the physical size and property after the interaction with the albumin protein. FIG. 2E the auto-correlation function obtained of the self-assembled organic nanosensor with albumin protein has displayed similar exponential decay of the auto-correlation function as has been shown by the nanosensor alone. Thus, the DLS data of nanosensor in presence and absence of albumin protein remains similar suggesting that the nanosensor is stable even in presence of the protein and does not disassemble. The binding mode of albumin to self-assembled organic nanosensor should be many to one in contrary to the binding mode of albumin to monomeric backbone of one to many FIG. 3.

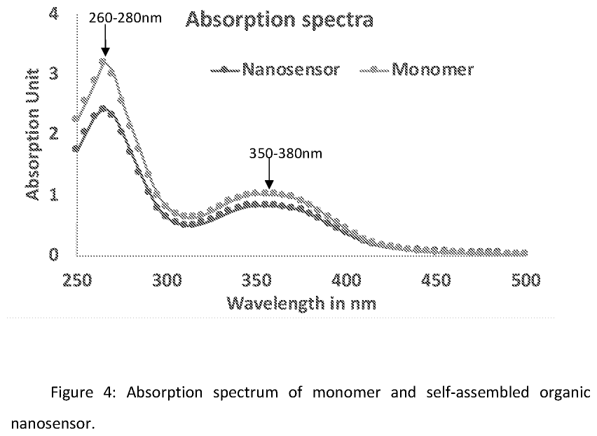

The absorption spectrophotometric analysis of the self-assembled organic nanosensor and monomeric backbone has been studied using the following protocol. The self-assembled organic nanosensor was taken in a tube with pH 7 phosphate buffer 100 mM in a 1:100000 weight by volume ratio. The solution is transferred to a cuvette compatible for absorption spectrophotometry in UV-VIS range. The absorption spectrum was analyzed in Cary 100 Agilent Technologies, Inc. using Cary 100 software. The absorption spectrum was determined between 250 nm to 700 nm. The self-assembled organic nanosensor and monomeric backbone, in both the cases, two distinct peaks has been observed, the peak 1 was between wavelength 260-280 nm with absorption maxima at 262 nm and the peak 2 was between wavelength 350-380 nm with absorption maxima at 352 nm (FIG. 4). Thus, the electronic structure of the monomeric backbone and self-assembled organic nanosensor remained similar despite difference in the size. The light absorbed by the monomer is at least 1.2 times higher than the self-assembled organic nanosensor, FIG. 4.

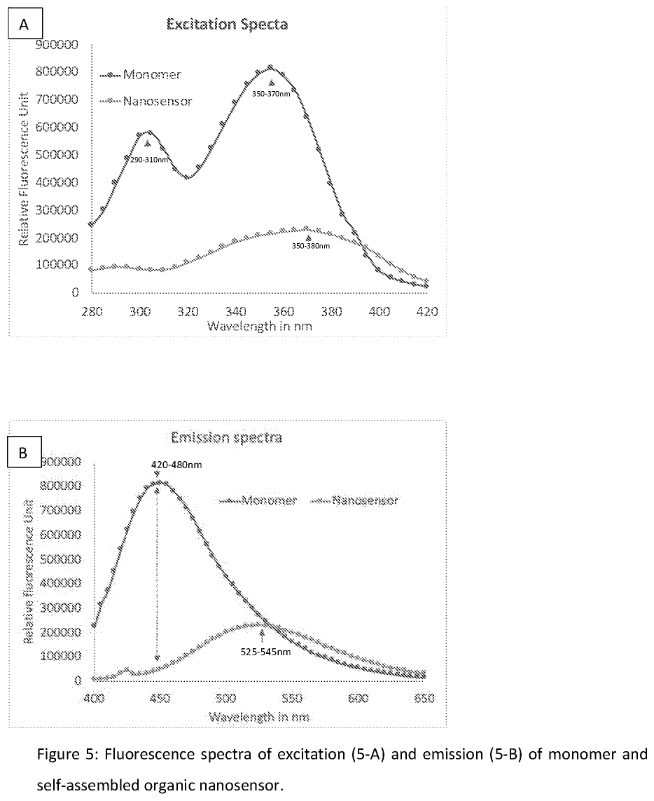

The fluorescence spectrophotometric analysis of the self-assembled organic nanosensor is described herein. The self-assembled organic nanosensor was taken in a tube with pH 7 phosphate buffer 100 mM in a range of 1:100000 to 1:1000 weight by volume ratio. The solution is transferred to a fluorescence compatible cuvette and analyzed for two-dimensional fluorescence in the wavelength range of excitation from 280 nm to 420 nm and emission from 400 nm to 650 nm, in a fluorescence spectrophotometer Fluoromax-4 Horiba, Ltd. using the Fluoromax-4 software. Using the same protocol monomeric backbone has also been analyzed for their fluorescence spectrum. The self-assembled organic nanosensor has single broad excitation with maxima at 350-380 nm while the monomeric backbone has two excitation peaks with maxima between 290-310 nm and 350-370 nm (FIG. 5-A). The emission spectrum of the nanosensor has single low intensity broad peak with maxima between 525-545 nm while the monomeric backbone has single high intensity peak between 420-480 nm (FIG. 5-B). Further, the monomeric backbone for the same quantity as nanosensor weight by weight has higher emission 16 times at 450 nm wavelength. The auto-fluorescence of a momomeric dye contributes towards the noise of the detection and results in low signal to noise ratio. Thus, the self-assembled organic nanosensor with low auto-fluorescence will have high signal to noise ratio. Therefore, the self-assembled organic nanosensor has different fluorescence behavior than the monomeric backbone both in the excitation and emission spectral are characteristically different both at peak position and peak height (FIG. 5).

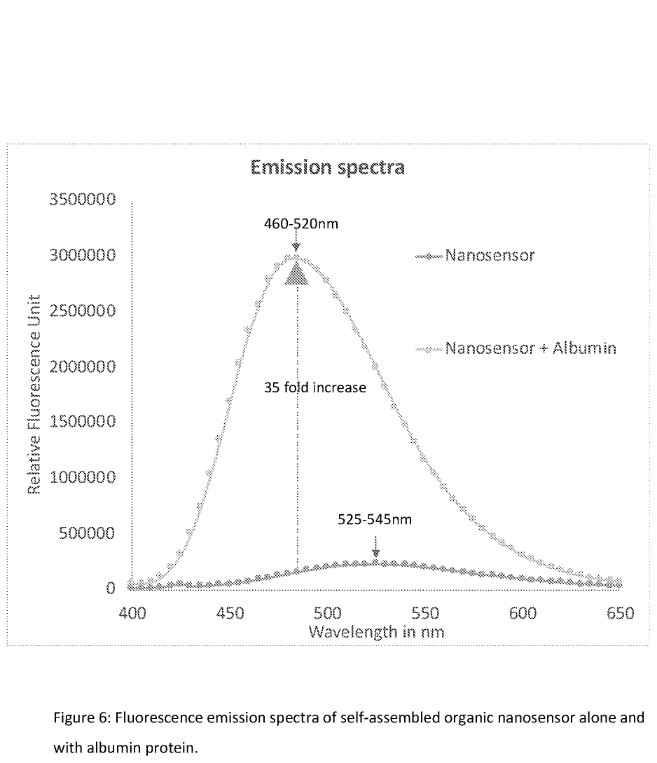

The interaction of the self-assembled organic nanosensor and monomeric backbone with albumin protein has been studied using the following method. The self-assembled organic naosensor was taken in a tube with phosphate buffer 100 mM in a range between 1:100000 weight by volume ratio. In this solution from the stock of albumin protein of concentration 1 gram per liter (g/L) was added to a final concentration of 88 milligram per liter (mg/L). The fluorescence analysis was carried out for the emission in the wavelength range from 400 nm to 650 nm in a fluorescence spectrophotometer Fluoromax-4 Horiba, Ltd. Using the same protocol monomeric backbone has also been analyzed with albumin protein for their fluorescence spectrum where the ratio of the monomeric backbone to 100 mM phosphate buffer pH 7 was 1:10000 and the albumin protein concentration used for the analysis was 88 mg/L. The analysis has shown that the fluorescence spectrum of the self-assembled organic nanosensor shows the blue shift phenomenon with albumin protein while the monomeric form shows red shift with albumin protein. A spectral shift towards lower wavelengths from higher wavelength upon interaction with the analyte is called a blue-shift or hypsochromic shift whereas a spectral shift towards higher wavelengths from lower wavelength upon interaction with the analyte is called a red-shift or a bathochromic shift. This indicates a fundamental difference in sensing principle between the monomeric backbone and the disclosed self-assembled organic nanosensor. The self-assembled organic nanosensor has auto-fluorescence emission maxima between 525-545 nm while with albumin the emission maxima shift to lower wavelength, i.e., 460-520 nm, However, the monomeric form shows auto-fluorescence emission maxima is 450 nm while with albumin the emission maxima shift to higher wavelength, i.e., 475 nm FIG. 6. The fold increase in relative fluorescence in monomeric backbone with and without albumin protein at 450 nm wavelength is 3 times while the fold increase in relative fluorescence in nanosensor with and without albumin protein at 470 nm wavelength is 34.6 times. Thus, the low auto-fluorescence of self-assembled organic nanosensor is advantageous to improve the signal to noise ratio and thereby detection of the analytes at lower concentration with higher resolution.

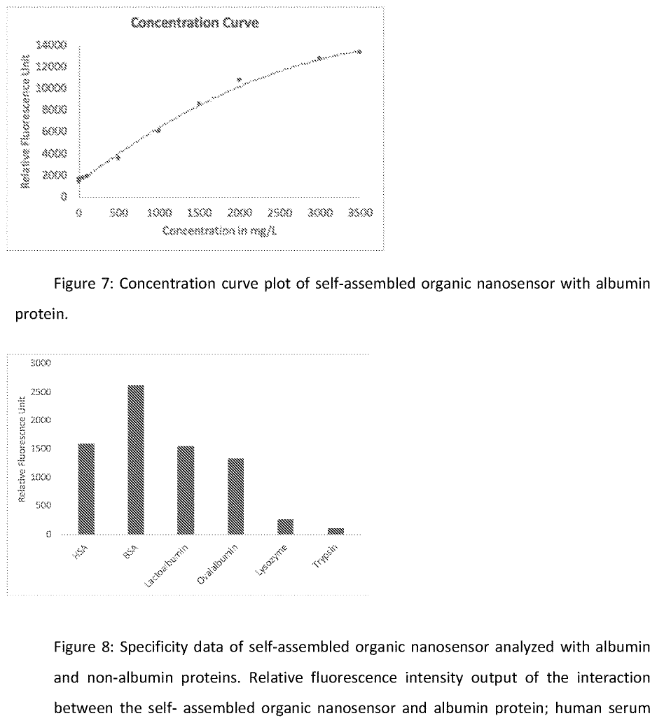

The range of detection of the assay with self-assembled organic nanosensor has been determined to be from 0.1 mg/L to 3500 mg/L of albumin protein. The analysis was carried out using fluorescence spectrophotometer Proflo-U® from Prantae Solutions Pvt. Ltd. with illumination source of wavelength 320-400 nm and the emission captured with photosensor, where the self-assembled organic nanosensor was taken in a tube with phosphate buffer 100 mM in 1:1000 weight by volume ratio. The relative fluorescence unit was measured. Albumin protein was added to the self-assembled organic nanosensor solution from the albumin stock to achieve the required concentration of the albumin protein. The ratio of the albumin protein sample to self-assembled organic nanosensor solution used was 1:10. The albumin concentration studied to determine the range was 0.1, 1, 10, 50, 100, 500, 1000, 1500, 3000 and 3500 mg/L. The relative fluorescence value was determined using fluorescence spectrophotometer system with illumination source of wavelength 320-400 nm has been used and where the self-assembled organic nanosensor showed interaction with 0.1 mg/L to 3500 mg/L albumin protein concentration and generated detectable fluorescence, FIG. 7. The fluorescence intensity was proportional to the concentration of the albumin protein in the aqueous solution. The monomeric backbone of same weight saturates beyond 500 mg/L. Thus, suggesting the self-assembled organic nanosensor having property of nanoparticle of high surface to volume ratio able to interact with more albumin protein molecules and hence broader range of albumin protein detection can be observed. Further, the monomeric backbone for the same amount fails to resolve the concentration below 10 mg/L. This is due to high auto-fluorescence of the monomeric dye that in-turn results in low signal to noise ratio and hence resolution in the lower concentration regime.

The self-assembled organic nanosensor has higher specificity for albumin protein in comparison to the non-albuminous protein. FIG. 8, three different forms of albumin proteins, namely human serum albumin, bovine serum albumin, ovalalbumin and non-albuminous protein tyrosine and lysozyme each with concentration of 100 mg/L. The analysis was carried out using fluorescence spectrophotometer Proflo-U from Prantae Solutions Pvt. Ltd. with illumination source of wavelength 320-400 nm and the emission captured with photosensor. The relative fluorescence unit was measured. low or negligible fluorescence observed in case of non-albuminous protein while high fluorescence observed with albuminous proteins.

The reaction time between the self-assembled organic nanosensor and the albumin protein is less than 10 seconds. A time course study has been conducted with visual inspection of fluorescence with excitation light source of 380 nm. The 100 mg/L concentration of Bovine Serum Albumin was added to self-assembled organic nanosensor solution. The green fluorescence was visually inspected at 90 degree to the incident light after 0, 5, 10, 15, 20, 30, 60, 120 seconds. The fluorescence starts appearing between 5 to 10 seconds, Table 1. Thus, the interaction between the albumin and self-assembled organic nanosensors is rapid and remain stable for long period thus enable rapid detection between 5 to 10 seconds and remain stable till 120 seconds of the study period.

TABLE 1
Time period study of the fluorescence reaction between
albumin protein and self-assembled organic nanosensors

| Time period after | | |
|---|---|---|
| addition of | Fluorescence Observed | Intensity of fluorescence |
| 0 | No | − |
| 5 | Yes | + |
| 10 | Yes | ++ |
| 15 | Yes | +++ |
| 0 | Yes | +++ |
| 30 | Yes | +++ |
| 60 | Yes | +++ |
| 120 | Yes | +++ |

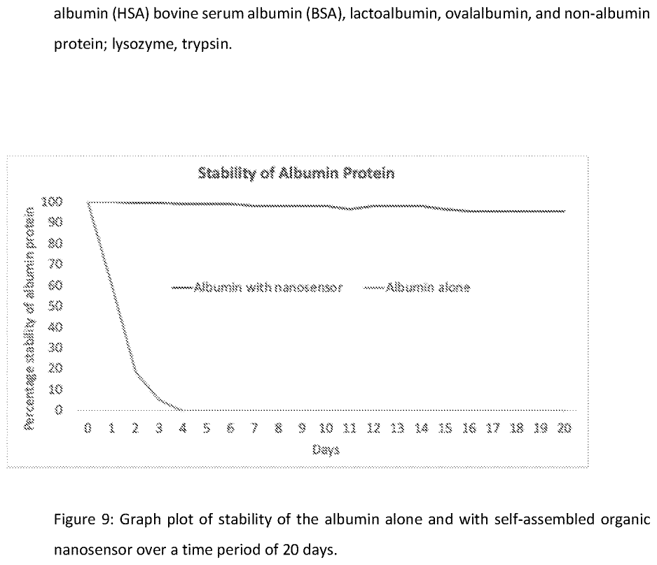

The albumin protein in complex with the self-assembled organic nanosensor in aqueous solution has been found to more stable than the aqueous solution of albumin protein at 27 degree Celsius. The reaction mixture has been prepared using the self-assembled organic nanosensor in a 100 mM phosphate buffer pH 7 in a volume of 3.4 ml where the nanosensor was in 1 part weight by 10000 part volume of the buffer. Two different concentration of albumin protein was tested 100 mg/L and 330 mg/L. Each of the albumin protein concentrations are incubated in phosphate buffer pH 7 with and without self-assembled organic nanosensor and the stability in respect of fluorescence was examined every day for 20 consecutive days. The stability of the albumin protein samples with self-assembled organic nanosensor has been determined with relative fluorescence value and compared with the zero day fluorescence as reference. The stability of albumin protein samples incubated in only buffer solution has been determined with relative fluorescence value by adding nanosensor in 1 part weight by 10000 part volume of the buffer and compared with the zero day fluorescence as reference. The relative fluorescence unit was determined using fluorescence spectrophotometer Proflo-U® with illumination source of wavelength 320-400 nm and the emission captured with photosensor over a period of 20 days at 27 degree Celsius temperature. The albumin protein in buffer lost 50% fluorescence within 1 day and more than 90% within 3 days, while the albumin protein incubated with self-assembled organic nanosensor in buffer show high stability with only 4% decrease observed till 20 days of study period. FIG. 9. Thus, the nanosensor stabilizes the albumin protein that is naturally liable to degradation at 27 degree Celsius in aqueous solution.

The thermostability of the self-assembled organic nanosensors has been tested by incubating the nanosensor at two extreme temperatures, namely, −80° C. and 95° C. for 120 minutes. The self-assembled organic nanosensors was then brought down to 27° C. and tested for fluorescence activity with 100 mg/L, 200 mg/L and 300 mg/L with excitation at wavelength 350-400 nm. The self-assembled organic nanosensors retained 100% activity at both minus (−) 80° C. and plus 95° C., Table 2.

TABLE 2
Thermostability of the nanosensor

| | |
|---|---|
| | Fluorescence activity retained |
| Temperature treatment | by the nanosensor |

| | | |
|---|---|---|
| 27° | C. | 100% |
| −80° | C. | 100% |
| 90° | C. | 100% |

The self-assembled organic nanosensor is used as a kit that can enable measurement of albumin from the environmental, biological or synthetic sample on field, or on site or point of care in solid state or in solution for testing and diagnosis.

The kit comprises of the self-assembled organic nanosensor in aqueous solution filled in an optically clear chamber, where the chamber can be but not restricted to microfluidic chamber, tube, vial, cuvettes made of plastic, glass or quartz. The chamber can be sealed, covered or open.

Albumin protein sample should be added to the chamber, where the volume of the albumin protein sample can be 1:50 to 10:1 of the self-assembled organic nanosensor solution. The albumin protein sample can be but not restricted to synthetic material or biological sample or environmental sample. The albumin protein sample should be mixed with the self-assembled organic nanosensor solution by manual or automated shaking, pipetting or vortexing. The interaction output of self-assembled organic nanosensor and albumin protein as fluorescence can be observed visually or using fluorescence spectrophotometer or imaging system, where the input light should be in the range of 320-400 nm and perpendicular to the angle of the observation.

In another embodiment, the kit comprises of the self-assembled organic nanosensor entrapped in a solid matrix, where the solid matrix can be but not restricted to nitrocellulose membrane, filter paper, glass slide and other solid surfaces. The self-assembled organic nanosensor entrapped in a solid matrix can be dipped into the sample containing albumin protein solution or the albumin protein solution can be poured over the self-assembled organic nanosensor entrapped in a solid matrix or the protein can be spotted on the self-assembled organic nanosensor entrapped in a solid matrix. The interaction output of self-assembled organic nanosensor and albumin protein as fluorescence can be observed visually or using fluorescence imaging system, where the input light should be in the range of 350-400 nm and perpendicular to the angle of the observation.

Following exhibits the nonlimiting examples which describes the efficacy of the system.

### EXAMPLES

Albumin protein standard curve preparation for teaching and training.

Standard solution of Bovine Serum Albumin (from Himedia) protein stock of 10 mg/ml is prepared in 1× Phosphate Buffer Saline Buffer solution {137 mM NaCl (Sigma Aldrich, Cat No. S7653-250G Lot No. SLBV9983), 10 mM KH2PO4 (Merck Emplura® Cat No. 1.93605.5021 Lot No. DHOD701207), 1.8 mM Na2HPO4 (Merck Emprove® Essential Cat No. 1.06585.1000, Lot No. K51666285026)} pH7.4. Different concentrations of Bovine Serum Albumin (BSA) working solution of volume 1 ml has been prepared in PBS. The range has been determined using the standard BSA analyte solutions of concentrations, viz., 0, 1, 2, 4, 8, 12, 16, 20, 25, 30, 45, 60, and 90 mg/dL. The relative fluorescence value was measured for each concentration using fluorescence spectrophotometer Proflo-U® (Prantae Solutions Private Limited) with illumination source of wavelength 320-400 nm and the emission captured with photosensor. The concentration versus relative fluorescence unit was plotted to generate standard curve. The standard curve can be used for determining the unknown concentration of albumin protein in an unknown sample.

### Estimation of Albumin in Urine of Cattle

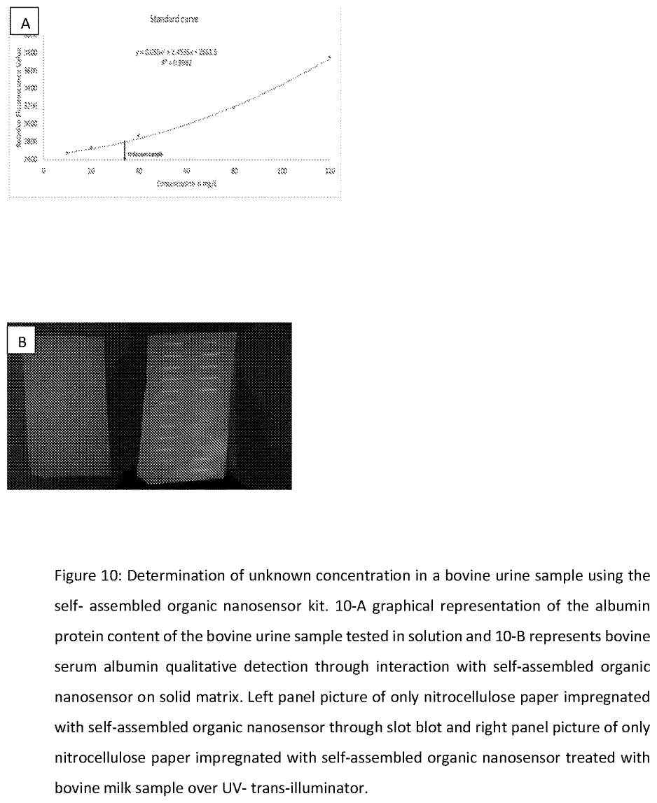

Urine is collected in a vial from a healthy bovine of a cattle shed. 170 microliter of the urine was added to the kit, self-assembled organic nanosensor solution volume 1530 microliter in an optically cleared chamber made of acrylic. Sample was mixed by shaking and observed with fluorescence spectrophotometer at an excitation wavelength of 380 nm. The relative fluorescence obtained was 2802. The fluorescence intensity was converted into concentration using the standard curve plotted using standard bovine serum albumin solution as described in the previous example (FIG. 10-A). The concentration of the sample (unknown) was determined to be 34 mg/L

### Estimation of Albumin in a Milk Sample

Bovine milk was collected in a container and diluted by 20 times with 1× Phosphate Buffer Saline Buffer solution {137 mM NaCl (Sigma Aldrich, Cat No. S7653-250G Lot No. SLBV9983), 10 mM KH2PO4 (Merck Emplura® Cat No. 1.93605.5021 Lot No. DHOD701207), 1.8 mM Na2HPO4 (Merck Emprove® Essential Cat No. 1.06585.1000, Lot No. K51666285026)} pH7.4. A nitrocellulose membrane impregnated with self-assembled organic nanosensor using slot-blot equipment, Bio-Rad Laboratories India Pvt. Ltd. was dipped into the 20 times diluted bovine milk sample for 60 seconds and then washed with 1× Phosphate Buffer Saline Buffer three times. The nitrocellulose membrane was then observed over UV trans-illuminator for qualitative detection of albumin in the sample (FIG. 10-B).

### Estimation of Albumin in Human Urine Sample

Human urine was collected in a container. 170 microliter of the human urine sample was added to the kit, self-assembled organic nanosensor solution volume 1530 microliter in an optically cleared chamber made of acrylic. Sample was mixed by shaking and observed with fluorescence spectrophotometer at an excitation wavelength of 380 nm. The relative fluorescence obtained was 8769. The fluorescence intensity was converted into concentration using the standard curve plotted using standard recombinant human serum albumin solution as described in the previous example (FIG. 10-A). The concentration of the sample (unknown) was determined to be 500 mg/L.

### Estimation of Albumin in Human Serum Sample

Human serum was collected and diluted 40 times with 1× Phosphate Buffer Saline Buffer solution {137 mM NaCl (Sigma Aldrich, Cat No. S7653-250G Lot No. SLBV9983), 10 mM KH2PO4 (Merck Emplura® Cat No. 1.93605.5021 Lot No. DH0D701207), 1.8 mM Na2HPO4 (Merck Emprove® Essential Cat No. 1.06585.1000, Lot No. K51666285026)} pH7.4. 170 microliter of the human urine sample was added to the kit, self-assembled organic nanosensor solution volume 1530 microliter in an optically cleared chamber made of acrylic. Sample was mixed by shaking and observed with fluorescence spectrophotometer at an excitation wavelength of 380 nm. The relative fluorescence obtained was 9546. The fluorescence intensity was converted into concentration using the standard curve plotted using standard recombinant human serum albumin solution as described in the previous example (FIG. 10-A). The concentration of the sample (unknown) was determined to be 2800 mg/L, considering the dilution factor.

### Advantage

Following are the advantages of the self-assembled organic nanosensors
1. The method is low cost as the self-assembled organic nanosensors are synthesized from low-cost monomeric backbone of naphthalene sulphonates
2. The synthesis is based on the cost-effective self-assembly process.
3. The nanoparticle assembly provides high surface to volume ratio thereby more analyte detection.
4. The self-assembled organic nanosensors has very low auto-fluorescence thereby show better signal to noise.
5. The self-assembled organic nanosensors can detect over a broad range of albumin concentration from 0.1 mg/L to 3500 mg/L.
6. The self-assembled organic nanosensors has high specificity for albumin protein.
7. The assay of detection albumin by self-assembled organic nanosensors is a simple one step method.
8. The fluorescence generated by the interaction of albumin and self-assembled organic nanosensors can be observed visually as well as with the fluorescence Spectrophotometer or imaging system.
9. The interaction of albumin and self-assembled organic nanosensors is rapid and remain stable for long period thus enable rapid detection and no loss of detection upon time lapse.
10. The self-assembled organic nanosensors is highly stable even at extreme temperature conditions of −80° C. and 95° C.

It will be understood that the invention may be carried out into practice by skilled persons with many modifications, variations and adaptations without departing from its spirit or exceeding the scope of the claims in describing the invention for the purpose of illustration.

Any inclusion to or deletion from the embodiment occurred, the specification is herein deemed as modified thus fulfilling the written description of all elements used in the claims so appended.

1-10. (canceled)

11. A method for synthesizing a self-assembled organic nanosensor for albumin protein detection, the method comprising:
dissolving naphthalene sulphonate monomeric backbone in an alkaline solution to obtain an alkaline solution of naphthalene sulphonate monomeric backbone,
wherein concentration of naphthalene sulphonate monomeric backbone ranges from 100 millimolar (mM) to 5 molar (M),
wherein molarity of the alkaline solution ranges from 250 millimolar (mM) to 4 molar (M), and
wherein pH of the alkaline solution ranges from 8-12;
mixing the alkaline solution of naphthalene sulphonate monomeric backbone to buffered aqueous solution with a pH range of 3-5 to form a mixture, and
incubating the mixture in a closed container of glass or plastic for 12-86 hours in dark at temperature range of 27 to 57 degree Celsius to obtain a settled self-assembled organic nanosensor,
wherein molarity of the buffered aqueous solution ranges from 50 millimolar (mM) to 2.5 molar (M); and
separating the settled self-assembled organic nanosensors using centrifugation at 10000 rpm for 10 minutes to obtain a pellet, and resuspending the pellet in deionized water to obtain the self-assembled organic nanosensor for albumin protein detection.

12. The method as claimed in claim 11, wherein the alkaline solution is selected from barium hydroxide, sodium hydroxide, ammonium hydroxide, calcium hydroxide, lithium hydroxide, potassium hydroxides, or sodium bicarbonate.

13. The method as claimed in claim 11, wherein the buffered aqueous solution is selected from citrate, formate, ascorbate, phosphate, tris, or carbonate.

14. The method as claimed in claim 11, wherein ratio of the alkaline solution of naphthalene sulphonate monomeric backbone to the buffered aqueous solution ranges from 0.001 to 10.

15. The method as claimed in claim 11, wherein the albumin protein is selected from human serum albumin, bovine serum albumin or ovalalbumin.

16. The method as claimed in 11, wherein size of the self-assembled organic nanosensor ranges from 40 nanometer to 2000 nanometer.

17. The method as claimed in 11, wherein the self-assembled organic nanosensor is stable in aqueous solution at a temperature ranging from minus 80 degree Celsius to 95 degree Celsius.

18. The method as claimed in 11 wherein the self-assembled organic nanosensor is stable in presence of the albumin protein and does not disassemble wherein the albumin to self-assembled organic nanosensor acts in plurality binding mode with albumin to monomeric backbone.

19. The method as claimed in 11 wherein the self-assembled organic nanosensor stabilizes the albumin protein in aqueous solution for 20 days at 27 degree Celsius.

20. The method as claimed in 11, wherein the self-assembled organic nanosensor exhibits a single low auto-fluorescence emission in aqueous solution with peak maxima between 525-545 nm wavelength and high fluorescence between 460-520 nm wavelength with the albumin protein.

21. A self-assembled organic nanosensor having the molecular structure 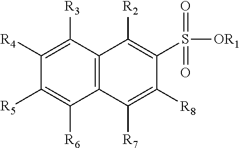
for albumin protein detection,
wherein the self-assembled organic nanosensor has improved signal to noise ratio.

22. The self-assembled organic nanosensor as claimed in claim 21, wherein the self-assembled organic nanosensor has higher specificity for the albumin protein compared to a non-albumin protein.

23. The self-assembled organic nanosensor as claimed in claim 21, wherein the self-assembled organic nanosensor has improved signal to noise ratio since fold increase in relative fluorescence in the self-assembled organic nanosensor with and without the albumin protein at 470 nm wavelength is 34.6 times.

24. The self-assembled organic nanosensor as claimed in claim 21, wherein the self-assembled organic nanosensor binds to 0.1 mg/L-3500 mg/L. concentration range of the albumin protein and exhibits fluorescence with peak maxima varying between 460-520 nm, and wherein fluorescence intensity varies proportionally to the concentration of the albumin protein.

25. The self-assembled organic nanosensor as claimed in claim 21, wherein the self-assembled organic nanosensor interacts with the albumin protein in a time range of 5 to 10 seconds.

26. The self-assembled organic nanosensor as claimed in claim 21, wherein the self-assembled organic nanosensor entrapped and conjugated to a solid matrix and is dipped into a sample containing the albumin protein entrapped in a solid matrix,
wherein interaction output of the self-assembled organic nanosensor and the albumin protein is observed as fluorescence, and
wherein input light is in the range of 320-400 nm and is perpendicular to angle of the observation.

27. The self-assembled organic nanosensor as claimed in claim 21, wherein the self-assembled organic nanosensor is stable in aqueous solution at a temperature ranging from minus 80 degree Celsius to 95 degree Celsius for 120 minutes.

28. The self-assembled organic nanosensor as claimed in claim 21, wherein the self-assembled organic nanosensor stabilizes the albumin protein in aqueous solution for 20 days at 27 degree Celsius.

29. The self-assembled organic nanosensor as claimed in claim 21, wherein size of the self-assembled organic nanosensor ranges from 40 nanometer to 2000 nanometer.

30. A kit comprising a self-assembled organic nanosensor having the molecular structure: 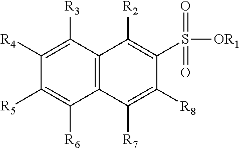
to detect an albumin protein.

31. The kit as claimed in claim 30, wherein the kit comprises a chamber,
wherein the chamber is selected from microfluidic chamber, tube, vial, cuvettes made of plastic, glass or quartz, and
wherein the chamber is sealed, covered or open.

32. The kit as claimed in claim 30, wherein volume of the albumin protein to the self-assembled organic nanosensor ranges from 1:50 to 10:1.
